(19) United States
(12) Patent Application Publication
(10) Pub. No.: US 2019/0338088 A1
(43) Pub. Date: Nov. 7, 2019

(54) BARRIER LAYERS

(71) Applicant: Brugg Rohr AG Holding, Brugg (CH)

(72) Inventors: Jürgen Kress, Oberwil-Lieli (CH); Christian Dambowy, Gebenstorf (CH)

(21) Appl. No.: 16/310,089

(22) PCT Filed: Jul. 11, 2017
(86) PCT No.: PCT/EP2017/067413

§ 371 Date: Dec. 14, 2018

(30) Foreign Application Priority Data
Jul. 20, 2016 (CH) 00936/16

(51) Int. Cl. C08J 5/18; C08F 210/02; C08F 216/06; C08F 216/36; C08F 210/06; B32B 7/12; B32B 27/30; B32B 27/32; B32B 27/28; B01D 53/22; B01D 71/38; B01D 69/12

(52) U.S. Cl. CPC C08J 5/18; B32B 2553/00; C08F 216/06; C08F 216/36; C08F 210/06; B32B 7/12; B32B 27/306; B32B 27/32; B32B 27/288; B01D 53/228; B01D 71/38; B01D 69/12; C08F 2800/10; C08J 2323/08; C08J 2329/04; C08J 2329/12; C08J 2323/14; B32B 2307/7242; C08F 210/02

(57) ABSTRACT

The invention relates to the use of special polymer layers as barriers, in particular as barrier layers in composite materials. Suitable polymers for the polymer layer are copolymers consisting of ethylene and vinyl alcohol or consisting of ethylene and carbon monoxide or consisting of ethylene and carbon monoxide and propylene. These barrier layers exhibit a selective barrier effect with respect to different gases, the barrier effect being especially effective with respect to HFOs. On account of these properties, such barrier layers can positively affect insulating properties, for example in thermally insulated pipes.

### CROSS-REFERENCE TO RELATED APPLICATIONS

This application is a National Stage application of International Patent Application No. PCT/EP2017/067413, filed on Jul. 11, 2017, which claims priority to Swiss Patent Application No. 00936/16, filed on Jul. 20, 2016, each of which is hereby incorporated by reference in its entirety.

### TECHNICAL FIELD OF THE INVENTION

The invention relates to the use of special polymers as barrier layers, in particular as barrier layers in composite materials. These barrier layers exhibit a selective barrier effect with respect to different gases, the barrier effect being especially effective with respect to HFOs. On account of these properties, such barrier layers can positively affect insulation properties, for example in thermally insulated pipes.

### BACKGROUND OF THE INVENTION

Foams for insulation are known materials. Such foams have numerous applications, in particular for thermal insulation, and are therefore important components in a large number of applications. The insulating properties of foams are dependent on several parameters, inter alia on the composition of the cell gases.

A known class of foams is polyurethane foams (PU), which consist of a polyol and an isocyanate. In order to produce these foams, another physical foaming agent is usually also added and is typically stirred into the polyol component, which is then mixed with the isocyanate in a high-pressure mixing head immediately before the two-component mixture (2C) is metered. This physical foaming agent is a first component of cell gases in PU foams. The polyol component typically contains a certain amount of water, with a typical range being 0.5 to 1.5 wt. %. This water results in the following reactions: a) reaction with the isocyanate to form carbamic acid, which is, however, unstable and, when carbon dioxide splits off, immediately disintegrates to form the corresponding amine; b) reaction of the amine thus produced with another isocyanate molecule to form the corresponding urea.

This reaction leads to the formation of further cell gases in PU foams and thus assists with the foaming process. The urea produced is advantageous for the thermal stability of the foam produced. Details relating thereto are described in Oertel et al (Polyurethane, editor Gunter Oertel, 3rd edition 1993, Hanser Verlag, p. 13; p. 94).

In stark contrast to chlorofluorocarbons (HFCs), hydrofluoroolefins (HFOs) are a known class of compounds that are known for their low global warming potential (GWP). Since HFOs are not combustible either, they are used as foaming agents, as is mentioned in WO2016/094762, for example. HFOs positively affect the insulating properties of foams.

Polymer materials generally have a certain degree of permeability to all types of permeants (gaseous or liquid). However, polymers differ markedly by the amount of a specific permeant that migrates through a given material per unit of time in each case. The use of polymer materials as barrier layers for the gases in the air, in particular nitrogen (N₂), oxygen (O₂), carbon dioxide (CO₂) and water (H₂O) is known per se. EP 1355103 thus describes a barrier based on EVOH or PVDC, which reduces diffusion of the CO₂, N₂ and O₂ gases but is simultaneously permeable to water. EP2340929 describes an EVOH layer as a barrier with respect to O₂ and CO₂. WO92/13716 describes EVOH layers as barriers with respect to HFCs. As set out above, HFCs have in principle different properties when compared with HFOs.

In light of this, it appears to be desirable to provide foams having improved insulating properties.

It also appears to be desirable to provide materials having barrier properties, in particular having selective barrier properties.

### SUMMARY OF THE INVENTION

The objects outlined above are solved according to the independent claims. The dependent claims constitute advantageous embodiments. Additional advantageous embodiments can be found in the description and the figures. Any of the general, preferred and particularly preferred embodiments, ranges, etc. given in connection with the present invention can be combined with one another. Likewise, individual definitions, embodiments, etc. may be omitted or may not be relevant.

The present invention is described in detail below. It goes without saying that any of the various embodiments, preferences and ranges disclosed and described below can be combined. In addition, depending on the embodiment, specific definitions, preferences and ranges may not be used. Furthermore, the term “comprising” includes the meanings “containing” and “consisting of”.

The terms used in the present invention are used in the usual sense, with which a person skilled in the art is familiar. Provided the direct connection does not have another meaning, the following terms have in particular the meaning/definitions given here.

### BRIEF DESCRIPTION OF THE DRAWINGS

The present invention is also illustrated by the figures; in addition to the following description, further embodiments of the invention can be found in these figures.

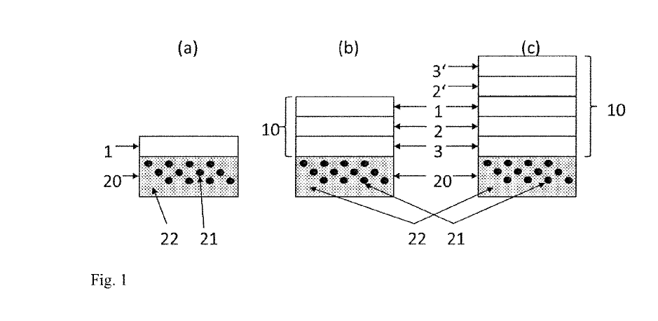

FIG. 1 is a cross-sectional schematic view of the structure of a composite material (10) according to the invention on a foam lagging (20). In this figure, the polymer (22) of the lagging (20) and (21) is the HFO-containing cell gas of the lagging (20). Various embodiments of the barrier (1) are shown:
(a) as a self-supporting structural element (1);
(b) as a composite material (10) having an outer barrier (1), an adhesion promoter (2) and thermoplastics (3);
(c) as a composite material (10) having an inner barrier (1), an adhesion promoter (2, 2′) and thermoplastics (3, 3′).

### DESCRIPTION OF THE PREFERRED EMBODIMENTS

The invention therefore relates to the use of a polymer layer as a barrier (1) for gases, the polymer of the polymer layer comprising a copolymer consisting of ethylene and vinyl alcohol or a copolymer consisting of ethylene and carbon monoxide or a copolymer consisting of ethylene and carbon monoxide and propylene; and said gas being selected from the group of hydrofluoroolefins.

It has been found that hydrofluoroolefins HFO, in particular as a cell gas (21) in a foam (22), are held back by said polymer layer (1) very effectively. As a result, the loss over time of these cell gases in a foam, for example, can be minimized in order to preserve the thermal insulating effect of this foam for a long period of time.

It has also been found that the polymer layer (1) described here has a relatively high degree of permeability to carbon dioxide. The carbon dioxide generated when a polyurethane foam (PU) is formed, for example, can therefore leave the polymer layer (1) over time by means of diffusion.

It has also been found that production methods for the use described here can be implemented in a simple and cost-effective manner and can be integrated in a continuous process.

This use and the individual features shall be explained in the following.

Barrier (1): diffusion barriers are known in several fields of technology, for example in the field of conduit pipes/pipe systems.

According to the invention, the barrier (1) is in the form of a layer. According to the invention, the barrier can be provided as a single layer or as several separate layers.

The values for the permeability of polymer materials vary over very wide ranges; more than the factor 10⁵. The criteria relating to the presence of a barrier effect are different for different permeants.

The measured values for O₂, N₂ and CO₂ (determined according to ISO 15105-1) are usually given in cm³/m²*day*bar. If the values are smaller than 20, the barrier effect is good and the polymer is considered to be impermeable. If the values are greater than 100, a barrier effect is no longer provided and the polymer is considered to be permeable. For values therebetween, the polymer is considered to be semi-permeable.

The measured values for HFO (determined according to ISO 15105-1:2007-10), Cp (determined according to ISO 15105-2:2003-02) and water (determined according to ISO 15105-3:2003-01) are usually given in ml/m²*day. If the values are smaller than 3, the barrier effect is good and the polymer is considered to be impermeable. If the values are greater than 20, a barrier effect is no longer present and the polymer is considered to be permeable. For values therebetween, the polymer is considered to be semi-permeable.

The invention also relates to the use of a polymer layer as a selective barrier (1) for gases, the polymer of the polymer layer comprising a copolymer consisting of ethylene and vinyl alcohol or a copolymer consisting of ethylene and carbon monoxide or a copolymer consisting of ethylene and carbon monoxide and propylene as described here; and said barrier preferably being
impermeable to gases from the group of HFOs;
permeable to water and water vapor;
semi-permeable to carbon dioxide; and
impermeable to gases from the surrounding area, in particular nitrogen and oxygen and air; or
said barrier preferably being
impermeable to gases from the group of HFOs;
semi-permeable to water and water vapor;
impermeable to carbon dioxide; and
impermeable to gases from the surrounding area, in particular nitrogen and oxygen and air.

It has been found that the barriers (1) described here meet these requirements very well.

The polymer layer (1) advantageously has the following diffusion coefficients:
HFOs less than 3 ml/m²*day
H₂O (gas) more than 3 ml/m²*day
CO₂ more than 20 cm³/m²*day*bar
O₂ less than 20 cm³/m²*day*bar
N₂ less than 20 cm³/m²*day*bar

These values can be achieved in particular by selecting the polymers and/or the layer thickness. Such values have proven to be advantageous for numerous applications, in particular in the field of laggings, for example for conduit pipes.

Barrier effect with respect to HFOs: due to their low degree of thermal conductivity, HFOs are advantageous cell gases in laggings. It is accordingly advantageous to hold said gases back in the insulating material. The layer described here allows for the diffusion of HFOs through the layer (1) to be reduced. This property is important, for example in order to ensure the insulating capacity of a conduit pipe/pipe system over a long period of time.

Barrier effect with respect to water vapor: prevention of the diffusion of said water vapor should not too great, since this otherwise runs the risk of said water vapor accumulating in the lagging and therefore impairing the degree of thermal conductivity.

In addition, the accumulation of moisture in the lagging also risks damaging said lagging. In an advantageous embodiment, the layer described here also allows for water to diffuse out of the lagging. This property is particularly important for conduit pipes/pipe systems, the medium pipe of which is made of plastics material. If an aqueous medium is transported in such conduit pipes/pipe systems, water can be transferred from the medium, through the conduit pipe and into the lagging, and can therefore reduce the insulating capacity and damage the foam lagging.

Barrier effect with respect to carbon dioxide: in an advantageous embodiment, the layer described here also provides a certain degree of permeability to CO₂. A particularly suitable value for the CO₂ permeability is in the range of 0.5 to 100 cm³/m²*day*bar.

Barrier effect with respect to oxygen: O₂ can lead to the oxidative damage of the insulating material, especially at high use temperatures, as in plastics jacketed pipes (PJP). Therefore, cell gases should not contain O₂ and diffusion thereof into the lagging should be avoided.

Barrier effect with respect to nitrogen: first of all, N₂ is not expected to have an adverse effect on the PU foam, but the degree of thermal conductivity of N₂ of 26 mW/m*K is markedly higher than the other cell gases. As a result, its presence in the PU foam would also increase the degree of thermal conductivity thereof, which is not desirable.

The barrier layer can accordingly be adapted to the desired requirements profile. In order to produce foams having as low a degree of thermal conductivity as possible and to also maintain this low degree of thermal conductivity for a long period of time, said barrier layer aims to prevent the oxygen and nitrogen gases from diffusing into the foam, to allow for diffusion of the CO₂ out of the foam, and to prevent diffusion of HFOs out of the foam. The more effective this is, the better the properties of the foam.

The combination of cell gases (21) from the group of HFOs and barrier layers (1) according to the formulas (II), (III) and (IV) described here leads to particularly good, superadditive insulating properties in thermally insulated conduit pipes. Such a positive interaction between these components is surprising. Without being tied to any theories, this superadditive effect can be attributed to the barrier properties of the materials according to formulas (II), (III) and (IV).

Polymer: as shown, the barrier comprises a copolymer consisting of ethylene with either carbon monoxide (so-called polyketones) or with vinyl alcohol (so-called ethylene vinyl alcohols).

Polyketones (PK): in an advantageous embodiment, the barrier comprises a polymer that contains or consists of polyketone(s). The polymer layer accordingly comprises polyketones and blends of polyketones. Polyketones are materials that are known per se and are characterized by the keto group (C═O) in the polymer chain.

In this embodiment, the polymer advantageously comprises 50 to 100 wt. %, preferably 80 to 100 wt. % structural units of formula (II) or formula (III).

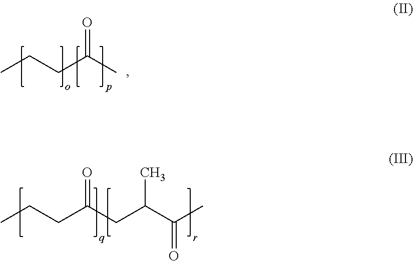

where
o represents 1 or 2, preferably 1,
p represents 1 or 2, preferably 1,
q represents 1 to 20, and
r represents 1 to 20.

In one embodiment, the polymer contains 90 to 100 wt. % structural units of formula (II), where o and p represent 1.

In one embodiment, the polymer contains 90 to 100 wt. % structural units of formula (III), where q and r represent, independently of one another, 1 to 20.

In one embodiment, the polymer of formula (II) has a molecular weight Mw of more than 20,000, in particular of 50,000 to 500,000. In one embodiment, the polymer of formula (III) has a molecular weight Mw of more than 20,000, in particular of 50,000 to 500,000.

In one embodiment, the polymer of formula (II) or formula (III) has a melting temperature above 200° C. (measured using DSC, 10 K/min according to ISO 11357-1/3).

In one embodiment, the polymer of formula (II) or formula (III) has a low degree of water absorption, preferably of less than 3%, measured according to DIN EN ISO 62:2008-05 (saturation in water at 23° C.).

Polyketones can be obtained by the catalytic conversion of carbon monoxide with the corresponding alkenes, such as propene and/or ethene. Such polyketones are also referred to as aliphatic polyketones. These polymers are commercially available, for example as polyketone copolymers (formula II) or polyketone terpolymers (formula III) from Hyosung. Such polyketones are also commercially available under the trade name Akrotek® PK.

In comparison with EVOHs (IV), PKs (II, III) have worse barrier properties with respect to O₂ and N₂, and a worse barrier effect with respect to H₂O and CO₂. Accordingly, one of these barrier materials can be advantageous depending on the planned use. For example, if medium pipes made of plastics material are used, it is of greater importance to allow for the migration of moisture in order to prevent their accumulation in the PU foam. If medium pipes made of metal are used, the effect of the migration out of the warm water being transported and into the foam is not noticeable. In this case, it may be of greater importance for the degree of thermal conductivity of the foam to be kept as low as possible for long periods of time, since the KMR pipes that are typically used are preferably used in classic district heating, where large amounts of energy are transported and losses have to be minimized.

Ethylene vinyl alcohols (EVOH): in another advantageous embodiment, the barrier comprises a polymer containing or consisting of ethylene vinyl alcohol.

In this embodiment, the polymer comprises 50 to 100 wt. %, preferably 80 to 100 wt. % structural units of formula (IV),

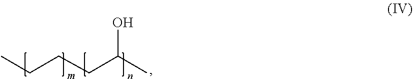

where
m represents 1 to 10, and
n represents 2 to 20.

Suitable EVOHs are in particular statistical copolymers, in which the ratio m/n is 30/100 to 50/100.

Suitable EVOHs in particular have a molecular weight Mw of more than 20,000, in particular of 50,000 to 500,000.

EVOHs are commercially available, for example as EVAL FP series or EP series from Kuraray. These are characterized by good processability, in particular they are very easy to process together with the jacket material polyethylene (PE) that is normally used by means of coextrusion, since the melt viscosities and melting temperatures thereof lie in a similar range.

In comparison with PKs (II, III), EVOHs (IV) display better barrier properties with respect to O₂ and N₂ and a better barrier effect with respect to H₂O and CO₂. These materials are accordingly particularly suitable in uses where there is little H₂O and/or CO₂. The considerations presented in connection with PK correspondingly apply here.

Gas: as mentioned above, the gas is selected from the group of hydrofluoroolefins (HFOs). This gas can be the cell gas (21) of a foam, in particular of a foam lagging (20), for example. This gas can consist of or contain HFOs. Typical additional components of the gas are in particular (cyclo)alkanes, CO₂, N₂, O₂ and H₂O.

Hydroolefins: HFOs are known and are commercially available or can be produced using known methods. The term includes both compounds that only comprise carbon, hydrogen and fluorine and compounds that also contain chlorine (also referred to as HFCOs) and each contain at least one unsaturated bond in the molecule. HFOs can be a mixture of different components or a pure component. HFOs can also be isomeric mixtures, in particular E-isomers/Z-isomers, or isomerically pure compounds.

Within the context of the present invention, HFOs that are particularly suitable have a boiling point above 0° C.

Within the context of the present invention, HFOs that are particularly suitable are selected from the group comprising compounds of formula (I),

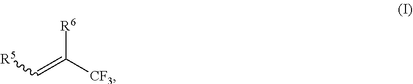

where R⁵ represents H, F, Cl, CF₃, preferably Cl, Cf₃, and R⁶ represents H, F, Cl, CF₃, preferably H.

Particularly suitable HFOs are 1233zd (for example Solstice LBA, from Honeywell) and 1336mzz (for example Formacel 1100, from DuPont).

It has surprisingly been found that thermally insulated conduit pipes have improved insulating behavior when the cell gases (21) of the lagging (20) contain at least 10 vol. %, preferably at least 30 vol. %, particularly preferably 50 vol. % HFO, and when this lagging is surrounded by a barrier (1), as described here.

(Cyclo)alkanes: these are known as the cell gas of the lagging in thermally insulated pipes. Said alkane or cycloalkane is advantageously selected from the group comprising propane, butanes, pentanes, cyclopentane, hexanes and cyclohexane. By combining (cyclo)alkane with HFO, the product properties can be finely adjusted and/or the producibility can be improved and/or the costs can be reduced together with a reasonable loss of quality. Said (cyclo)alkanes can be pure compounds or mixtures; the aliphatic alkanes can be isomerically pure compounds or isomeric mixtures. A particularly suitable (cyclo)alkane is cyclopentane (Cp).

Carbon dioxide (CO₂): this is known as the cell gas of the lagging in thermally insulated pipes. It can be formed as a byproduct of the production process or can be added in a specific amount. The CO₂ content of a cell gas is typically less than 50 vol. %.

Nitrogen (N₂), oxygen (O₂): the production process can cause components from the atmosphere/ambient air to enter the cell gas. These are substantially N₂ and/or O₂, for example air. The cell gas content is typically less than 5 vol. % at the time of production.

Water (H₂O): this can be in the form of a gas or a liquid. H₂O typically enters the lagging cell gas from the surrounding area by means of condensation or from an element carrying media by means of permeation.

In one embodiment, the invention therefore relates to the use described here, wherein the cell gas (21) is a mixture comprising 10 to 100 vol. % HFOs and 0 to 50 vol. % (cyclo)alkane and 0 to 50 vol. % CO₂.

Foam: as mentioned above, the gas can be the cell gas (21) of a foam, in particular of a foam lagging (20).

Such foams are known per se. Foams that meet the following standards: DIN EN 253:2015-12 (in particular for PJP) and EN15632-1:2009/A1:2014, EN15632-2:2010/A1:2014 and EN15632-3:2010/A1:2014 (in particular for PMP) are particularly suitable. The term includes hard foams and soft foams. Foams can be closed-celled or open-celled, preferably closed-celled, in particular as shown in the standard DIN EN 253:2015-12, for example. Such foams are preferably selected from the group of polyurethanes (PU), polyisocyanurates (PIR), thermoplastic polyesters (in particular PET) and thermoplastic polyolefins (in particular PE and PP).

The invention therefore also relates to the use of a polymer layer as a barrier (1) for gases, as described here, the gas being the cell gas of a foam, characterized in that said foam (polymer (22) and cell gas (21)) meets the following criteria:
PU containing 50 to 100 vol. % 1233zd and 0 to 50 vol. % Cp;
PU containing 50 to 100 vol. % 1336mzz and 0 to 50 vol. % Cp;
PIR containing 50 to 100 vol. % 1233zd and 0 to 50 vol. % Cp;
PIR containing 50 to 100 vol. % 1336mzz and 0 to 50 vol. % Cp;
PET containing 50 to 100 vol. % 1233zd and 0 to 50 vol. % Cp;
PET containing 50 to 100 vol. % 1336mzz and 0 to 50 vol. % Cp;
PE containing 50 to 100 vol. % 1233zd and 0 to 50 vol. % Cp; and/or
PE containing 50 to 100 vol. % 1336mzz and 0 to 50 vol. % Cp.

In one embodiment, said cell gases complement one another up to 100 vol. %. In another embodiment, these cell gases are complementary together with CO₂ and air up to 100%.

The invention also relates to the use described here, wherein said polymer layer (1) is a self-supporting structural element. The polymer layer (1) can therefore be a film or a molded body.

The invention also relates to the use described here, wherein said polymer layer (1) is part of a composite material (10). Such composite materials are known per se. For the use described here, said composite material (10) may have the following layered structure: thermoplastic polymer (3), optional adhesion promoter (2), polymer layer as a barrier (1) as described here, optional adhesion promoter (2′), optional thermoplastic polymer (3′). Components (2) and (3) are commercially available products known to a person skilled in the art.

Thermoplastic polymer (3): a wide range of thermoplastics can be used; these typically have a lesser barrier effect than the layer (1). Thermoplastic polymers (3, 3′) selected from the group comprising commercial types of PE, such as high-density PE (HDPE), low-density PE (LDPE), linear low-density PE (LLDPE) are advantageously used.

Adhesion promoters (2, 2′): a wide range of adhesion promoters can be used; these typically have a lesser barrier effect than the layer (1). Adhesion promoters (2, 2′) are advantageously selected from the group of PE graft copolymers, which have at least one other component, for example maleic anhydride. Such substances are commercially available under the brand name Amplify™ from Dow or under Admer™ from Mitsui, for example.

The thicknesses of said individual layers can vary over a wide range and depend on the desired barrier effect with respect to the individual permeants, on the material and lastly on production and cost considerations, inter alia. The following values have proven suitable: the layer thickness of the polymer layer (1) is advantageously in the range of 0.01 to 1 mm, preferably in the range of 0.03 to 0.5 mm, particularly preferably in the range of 0.05 to 0.3 mm. The layer thickness of the adhesion promoter layer (2, 2′) is advantageously in the range of 0.01 to 1 mm, preferably in the range of 0.05 to 0.5 mm, particularly preferably in the range of 0.1 to 0.3 mm in each case. The layer thickness of the thermoplastic polymer (3, 3′) is advantageously in the range of 0.01 to 1 mm, preferably in the range of 0.05 to 0.5 mm, particularly preferably in the range of 0.1 to 0.3 mm in each case.

The invention also relates to the use of a polymer layer as a barrier (1) or of a composite material (10) for gases, as described here, in numerous technological fields. The use according to the invention is not limited to one single use; instead, it can be used in all fields in which the barrier effect with respect to HFOs is useful or desirable.

The invention correspondingly relates to the use of a polymer layer (1) as described here or of a composite material (10) as described here
as a barrier material for laggings, in particular for cooling devices, for pipe systems for local and district heating, for pipe systems for cooling buildings, for pipe systems for transporting cooled media, for pipe systems in industrial applications, for pipe systems for transporting gases, liquids or solids; and/or
as a barrier material for packaging, in particular for pharmaceuticals, food and electric components; and/or
as a barrier material for containers and tanks.

Laggings: the term includes in particular thermally insulated pipe systems from the group of plastics media pipe systems (PMP) and plastics jacketed pipe systems (PJP). These are used for transporting heated or cooled media, in particular water or aqueous solutions. However, they can also be used to transport other substances and chemicals.

The invention is explained in more detail on the basis of the following non-limiting examples.

In a foam from the class of polyurethanes, at the end of the production process numerous cell gases are present. A summary of possible cell gases and their essential properties is shown in the table. The stated amounts for the types of foam given as examples relate to the values for freshly produced foams that have not aged.

| | Thermal | Content in foam | Content in foam |
|---|---|---|---|
| | conductivity | type 1 | type 2 |
| Cell gas | [mW/m * K] | [Vol. %] | [Vol. %] |
| N₂ | 26.0 | 1-2 | 1-2 |
| O₂ | 26.3 | 1-2 | 1-2 |
| CO₂ | 16.8 | 58 | 32 |
| Cp | 11.5 | 38 | 0 |
| HFO 1233zd | 10.0 | 0 | 65 |

### Example 1: Diffusion Through Polymer Films

The diffusion of O₂, N₂, CO₂, HF01233zd, Cp and H₂O through different polymer films has been experimentally determined in the manner described in the standards specified. The results are summarized in the table.

| Permeant | O₂ | N₂ | CO₂ | HFO1233zd | Cp | H₂O |
|---|---|---|---|---|---|---|
| Unit | [cm³/m²*day*bar] | | | [ml/m²*day] | | |
| Method | ISO15105-1, | | | ISO15105-1 | ISO15105-2 | ISO15106-3 |
| Temperature | 23° C. | | | 23° C. | 23° C. | 23° C. |
| Air moisture | 0% RH | | | — | — | 85% RH |
| | Experimentally | | | | | |
| LDPE | 7.600 | 2′343 | 31′106 | 69′950 | 12′150 | 4.00 |
| PK | 9.90 | 3.30 | 60.3 | 2.45 | <0.002 | 12.4 |
| PAN | 4.05 | 0.48 | 12.9 | <0.07 | <0.002 | 11.7 |
| EVOH | 0.25 | 0.07 | 0.9 | <0.02 | <0.002 | 0.5 |

Cp: cyclopentane; PK: aliphatic polyketone; EVOH: copolymer consisting of ethylene and vinyl alcohol; PAN: polyacrylonitrile; LDPE: low-density polyethylene.

According to the above definition, EVOH is a good barrier for all permeants observed. LDPE has practically no barrier effect, and only has a partial barrier effect with respect to water. Aliphatic PK and PAN have a good barrier effect with respect to O₂, N₂, HFO and Cp and a partial barrier effect with respect to CO₂ and H₂O.

With regard to practical application, the fact that PAN is tough to process, is brittle and is poorly commercial available is disadvantageous. EVOH and PK can be easily processed and are commercially available.

### Example 2: Measuring the Cell Gases of a Foam Following Aging Under Different Environmental Conditions

Film webs having a width of 20 to 30 cm were welded to form bags, which have a volume of approximately eight liters. These bags were filled with a PU foam, which contained cyclopentane as the foaming agent. Once the foaming process had finished, the bags were also welded at the upper end.

Each bag was then first cut and the composition of the cell gases was determined (day 0). The other samples were aged in two climatic chambers; the temperature of one of the climatic chambers being 70° C. and the relative air humidity (RH) being 10%, and the temperature of the other chamber being 70° C. and the relative humidity (RH) being 90%.

The values for the individual gases in vol. % are set out in the table.

It can be clearly seen that, for the materials EVOH and PAN, the barrier effect is heavily dependent on the humidity of the surrounding area.

From the results of example 1, a similar result is expected for HFO and Cp. EVOH and PK are therefore reasonable barrier layers for these gases.

| | O₂ | | N₂ | | CO₂ | | Cp | | |
|---|---|---|---|---|---|---|---|---|---|
| RH | 10% | 90% | 10% | 90% | 10% | 90% | 10% | 90% | Days |
| LDPE | 1.1 | 1.1 | 3.2 | 3.2 | 45.0 | 45.0 | 50.7 | 50.7 | 0 |
| | 21.4 | 14.6 | 16.0 | 15.5 | 2.7 | 1.3 | 59.9 | 68.6 | 128 |
| | 20.9 | 15.8 | 40.3 | 28.2 | 0.6 | 7.5 | 38.3 | 48.5 | 190 |
| PK | 0.5 | 0.5 | 1.8 | 1.8 | 54.7 | 54.7 | 43.0 | 43.0 | 0 |
| | 4.9 | 0.9 | 5.2 | 9.0 | 28.2 | 4.6 | 61.7 | 77.4 | 128 |
| | 14.3 | 16.5 | 22.0 | 21.5 | 9.5 | 1.6 | 54.3 | 60.4 | 190 |
| PAN | 0.7 | 0.7 | 2.5 | 2.5 | 55.2 | 55.2 | 41.7 | 41.7 | 0 |
| | 1.5 | 10.1 | 2.3 | 12.0 | 60.6 | 6.5 | 45.6 | 71.4 | 128 |
| | 4.3 | 16.1 | 10.3 | 21.4 | 51.8 | 2.4 | 33.7 | 6.0 | 190 |
| EVOH | 1.0 | 1.0 | 3.3 | 3.3 | 44.7 | 44.7 | 51.0 | 51.0 | 0 |
| | 1.1 | 10.9 | 2.9 | 11.4 | 64.6 | 2.8 | 31.4 | 74.9 | 128 |
| | 3.2 | 16.7 | 9.1 | 26.6 | 56.9 | 0.9 | 30.8 | 55.8 | 190 |

Whilst the present application describes preferred embodiments of the invention, it should be pointed out that the invention is not limited to these embodiments and can also have a different design within the scope of the claims that follow.

What is claimed is:

1. Use of a polymer layer as a barrier material for a gas, whereby
the layer thickness of the polymer layer is in the range of 0.03 to 0.5 mm; and
the polymer of the polymer layer comprises a copolymer of ethylene and vinyl alcohol or a copolymer of ethylene and carbon monoxide or a copolymer of ethylene and carbon monoxide and propylene; and
wherein said gas is selected from the group of hydrofluoroolefins (HFOs) having a boiling point above 0° C., comprising compounds of formula (I) 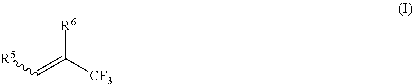
where R⁵ and R⁶ represent, independently of one another, H, F, Cl, CF₃.

2. The use according to claim 1, wherein said polymer contains 50 to 100 wt. % structural units of formula (II) or (III) or (IV), 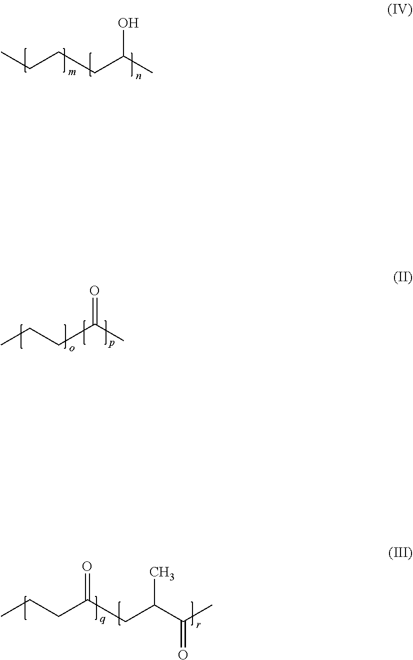
where
m represents 1 to 10,
n represents 2 to 20 (with m/n being 30/100 to 50/100)
o represents 1 or 2,
p represents 1 or 2,
q represents 1 to 20, and
r represents 1 to 20.

3. The use according to claim 1, wherein said polymer contains either 90 to 100 wt. % structural units of formula (II) 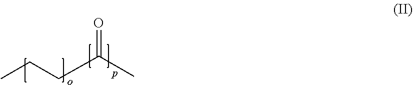
where o and p represent 1 and where the polymer preferably has a molecular weight Mw of more than 20,000; or
90 to 100 wt. % structural units of formula (III), 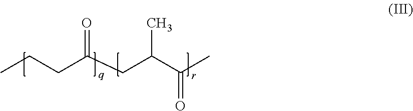
where q and r represent, independently of one another, 1 to 20, and where the polymer has a preferable molecular weight Mw of more than 20,000; or
90 to 100 wt. % structural units of formula (IV), 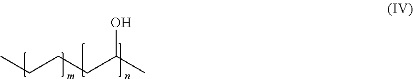
where m represents 1 to 10, n represents 2 to 20 and where the relationship m/n is from 3/10 to 5/10, and where the polymer preferably has a molecular weight Mw of more than 20,000.

4. The use according to claim 1, wherein said HFO is selected from the group 1233zd and 1336mzz.

5. The use according to claim 4, said wherein the selected HFO has a boiling point above 0° C.

6. The use according to claim 1, wherein said gas is the cell gas of a foam.

7. The use according to claim 6, wherein said cell gas is a mixture comprising 10 to 100 vol. % HFOs and 0 to 50 vol. % (cyclo)alkane and 0 to 50 vol. % CO₂.

8. The use according to claim 6, wherein said foam is a polymer selected from the group of polyurethanes (PU), polyisocyanurates (PIR), thermoplastic polyesters (PET) and thermoplastic polyolefins.

9. The use according to claim 6, wherein said foam comprises a polymer and cell gas and meets the following criteria:
PU containing 50 to 100 vol. % 1233zd and 0 to 50 vol. % cyclopentane (Cp);
PU containing 50 to 100 vol. % 1336mzz and 0 to 50 vol. % Cp;
PIR containing 50 to 100 vol. % 1233zd and 0 to 50 vol. % Cp;
PIR containing 50 to 100 vol. % 1336mzz and 0 to 50 vol. % Cp;
PET containing 50 to 100 vol. % 1233zd and 0 to 50 vol. % Cp;
PET containing 50 to 100 vol. % 1336mzz and 0 to 50 vol. % Cp;
PE containing 50 to 100 vol. % 1233zd and 0 to 50 vol. % Cp; and
PE containing 50 to 100 vol. % 1336mzz and 0 to 50 vol. % Cp.

10. The use according to claim 1, wherein the polymer layer has the following diffusion coefficients:
HFOs less than 5 cm³/m²*day*bar;
O₂ less than 20 cm³/m²*day*bar;
N₂ less than 5 cm³/m²*day*bar;
CO₂ more than 0.5 cm³/m²*day*bar; and
H₂O (gas) more than 0.4 g/m²*day.

11. The use according to claim 1, wherein said polymer layer is part of a composite material or is a self-supporting structural element.

12. The use according to claim 11, wherein said composite material has the following layered structure: a thermoplastic polymer, an optional adhesion promoter, said polymer layer as a barrier material, an optional adhesion promoter, and an optional thermoplastic polymer.

13. The use according to claim 12, wherein
the thermoplastic polymer is selected from the group consisting of high-density PE (HDPE), low-density PE (LDPE), linear low-density PE (LLDPE) and has a layer thickness of 0.01 to 1 mm; and/or
the adhesion promoter is selected from the group consisting of PE graft copolymers, which have at least one other component, and has a layer thickness of 0.01 to 1 mm.

14. The use of a polymer layer according to claim 1 as a barrier material for laggings, for cooling devices, for pipe systems for local and district heating, for pipe systems for cooling buildings, for pipe systems for transporting cooled media, for pipe systems in industrial applications, or for pipe systems for transporting gases, liquids or solids; and
as a barrier material for packaging, for pharmaceuticals, food and electronic components; and/or
as a barrier material for containers and tanks.

15. The use as according to claim 14 for thermally insulated pipe systems from the group of plastics medium pipe systems (PMP) and plastics jacketed pipe systems (PJP).

16. The use of a polymer layer or of a composite material according to claim 11 as a barrier material for laggings, for cooling devices, for pipe systems for local and district heating, for pipe systems for cooling buildings, for pipe systems for transporting cooled media, for pipe systems in industrial applications, or for pipe systems for transporting gases, liquids or solids; and/or
as a barrier material for packaging, for pharmaceuticals, food and electronic components; and/or
as a barrier material for containers and tanks.

17. The use of a composite material according to claim 16 for thermally insulated pipe systems from the group of plastics medium pipe systems (PMP) and plastics jacketed pipe systems (PJP).
